(19) United States
(12) Patent Application Publication
(10) Pub. No.: US 2012/0282565 A1
(43) Pub. Date: Nov. 8, 2012

(54) Dental appliance with tension band and method for making

(76) Inventor: Loren S. Adell, Collin County, TX (US)

(21) Appl. No.: 13/068,141

(22) Filed: May 2, 2011

(51) Int. Cl. A61C 7/08; A61C 13/36

(52) U.S. Cl. 433/6; 264/16

(57) ABSTRACT

A method of making an orthodontic appliance for repositioning teeth or as a retainer according to the present invention includes preparing a dental model for the fabrication of an orthodontic aligner, placing the dental model on a thermo-forming machine, thermoforming a soft flexible material onto the dental model, the soft flexible material having adhesive material covered by release liner, on the side facing away from the portion of the dental model to which it is thermoformed, trimming off excess soft flexible material from the dental model, peeling off the release liner to expose the adhesive material, applying a predetermined length of flexible tension strain material to the adhesive side of the soft flexible material, thermoforming a harder, more rigid material over the soft flexible material which has the flexible tension strain material attached, and trimming the excess hard material from the dental model. In a preferred form of the method, the soft flexible material has a pressure sensitive film on the patient's palate side, covered by a release liner. The method further includes the steps of removing the finished orthodontic appliance from the dental model, removing the remaining release liner from the soft flexible material, and placing the dental appliance into a patient's mouth.

### CROSS-REFERENCE TO RELATED APPLICATIONS

### STATEMENT REGARDING FEDERALLY SPONSORED RESEARCH OR DEVELOPMENT.

Not Applicable

### INCORPORATION-BY-REFERENCE OF MATERIAL SUBMITTED ON A COMPACT DISC.

Not Applicable

### BACKGROUND OF THE INVENTION

1. Field of the Invention

The present invention relates generally to the field of dentistry and, in particular, to dental appliances.

2. Description of Related Art

Dental Appliances, such as “invisible” retainers are now in regular use. Such dental appliances are made from a single material which is hard in order to retain its shape and exert sufficient pressure on a user's teeth.

U.S. Pat. No. 4,983,334 to Loren S. Adell shows a multilayer appliance forming a memory material.

U.S. Pat. No. 7,201,575 to Loren S. Adell shows the use of a combined blank with one layer of the blank substantially softer than the second layer.

### BRIEF SUMMARY OF THE INVENTION

A method of making an orthodontic appliance for repositioning teeth or as a retainer according to the present invention includes preparing a dental model for the fabrication of an orthodontic aligner, placing the dental model on a thermo-forming machine, thermoforming a soft flexible material onto the dental model, the soft flexible material having adhesive material covered by release liner, on the side facing away from the portion of the dental model to which it is thermoformed, trimming off excess soft flexible material from the dental model, peeling off the release liner to expose the adhesive material, applying a predetermined length of flexible tension strain material to the adhesive side of the soft flexible material as an outside peripheral band, thermoforming a harder, more rigid material over the soft flexible material which has the flexible tension strain material attached, and trimming the excess hard material from the dental model.

In a preferred method the flexible tension strain material is a fiber material. A preferred range for the fiber sizes are in a range of from about 0.05 mm to about 12 mm.

A preferred range for the thickness of the soft flexible material is in a range from about 0.010 inches to about 0.015 inches, and a preferred range for the thickness of the harder, more rigid material is in a range of from about 0.020 inches to about to about 0.040 inches.

In a preferred form of the method, the soft flexible material has a pressure sensitive film on the patient's palate side, covered by a release liner. The method further includes the steps of removing the finished orthodontic appliance from the dental model, removing the remaining release liner from the soft flexible material, and placing the dental appliance into a patient's mouth.

One method according to the present invention includes the step of etching the harder, more rigid material on the side facing the other materials to increase the adhesion to the other materials.

A dental appliance produced according to the method herein, includes a soft flexible material for fitting to a patient's teeth, a tension material affixed to at least part of the soft flexible material as an outside peripheral band, and a harder, more rigid material affixed to the tension material and to the soft flexible material.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is top right rear perspective view of a dental model for the fabrication of an orthodontic aligner;

FIG. 2 is a sheet of soft flexible material to be thermoformed on the dental model of FIG. 1;

FIG. 3 is the dental model of FIG. 1 with the sheet of soft flexible material of FIG. 2 thermoformed over it;

FIG. 4 is a top view of the dental model of FIG. 1 with the sheet of soft flexible material thermoformed over it and trimmed with an outer peripheral band of tension material affixed to the soft flexible material.

FIG. 5 is a top left rear perspective view of the apparatus of FIG. 4 removed from the dental model for illustration purposes;

FIG. 6 is a cross-sectional view of the three layers of the present invention;

FIG. 7 is one form of an outer peripheral band according to the present invention;

FIG. 8 is an alternative embodiment of an outer peripheral band according to the present invention;

FIG. 9 is an another alternative embodiment of an outer peripheral band according to the present invention;

FIG. 10 is an alternative embodiment of at least two peripheral bands according to the present invention; and

FIG. 11 is an alternative embodiment of the peripheral band according to the present invention.

### DETAILED DESCRIPTION OF THE INVENTION

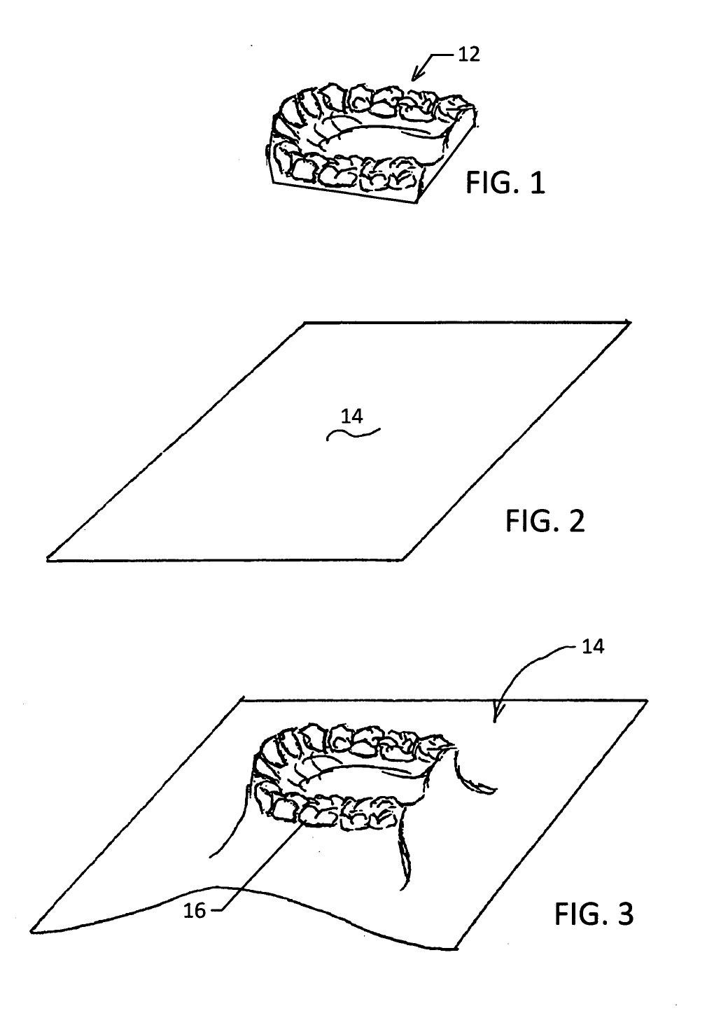

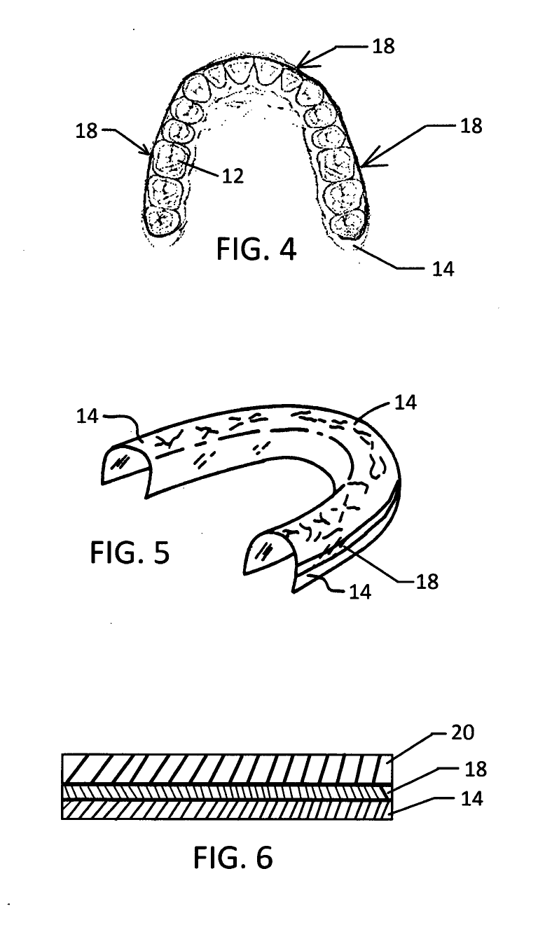

Referring now to the drawing, and in particular to the FIGS. 1 through 3, a method of making an orthodontic appliance for repositioning teeth or as a retainer according to the present invention includes preparing a dental model 12 for the fabrication of an orthodontic aligner, placing the dental model on a thermo-forming machine, thermoforming a soft flexible material 14 onto the dental model, the soft flexible material having adhesive material covered by release liner, on the side facing away from the portion of the dental model to which it is thermoformed. Referring now also to FIGS. 4 and 5, the method includes trimming off excess soft flexible material from the dental model, peeling off the release liner to expose the adhesive material, applying a predetermined length of flexible tension strain material to the adhesive side of the soft flexible material as at least one peripheral band 18, and referring also to FIG. 6, thermoforming a harder, more rigid material 20 over the soft flexible material which has the flexible tension strain material attached, and trimming the excess hard material from the dental model. Harder, more rigid material 20 is only in contact with flexible tension strain material where it forms at least one outside peripheral band 18. Elsewhere, harder, more rigid material 20 is in direct contact with soft flexible material 14. The flexible tension strain material forming the at least one peripheral band gives the dental appliance a strong tendency to maintain its original shape, constantly pulling the appliance back to its original shape. Any kind of stretchable plastic, a material such as silicone, or a strong fiber material will do, although it could also be some other kind of memory material.

In a preferred method the flexible tension strain material is a fiber material. A preferred range for the fiber sizes are in a range of from about 0.05 mm to about 12 mm.

A preferred range for the thickness of the soft flexible material is in a range from about 0.010 inches to about 0.015 inches, and a preferred range for the thickness of the harder, more rigid material is in a range of from about 0.020 inches to about to about 0.040 inches.

In a preferred form of the method, the soft flexible material has a pressure sensitive film on the patient's palate side, covered by a release liner. The method further includes the steps of removing the finished orthodontic appliance from the dental model, removing the remaining release liner from the soft flexible material, and placing the dental appliance into a patient's mouth.

One method according to the present invention includes the step of etching the harder, more rigid material on the side facing the other materials to increase the adhesion to the other materials.

A dental appliance produced according to the method herein, includes a soft flexible material 14 for fitting to a patient's teeth, a tension material 18 affixed to at least part of the soft flexible material as at least one peripheral band, and a harder, more rigid material 20 affixed to the tension material and to the soft flexible material. As can now be seen, the flexible tension strain material forming at least one peripheral band gives the dental appliance a strong tendency to maintain its original shape, constantly pulling the appliance back to its original shape. Any kind of stretchable plastic, a material such as silicone, or a strong fiber material will do, although it could also be some other kind of memory material.

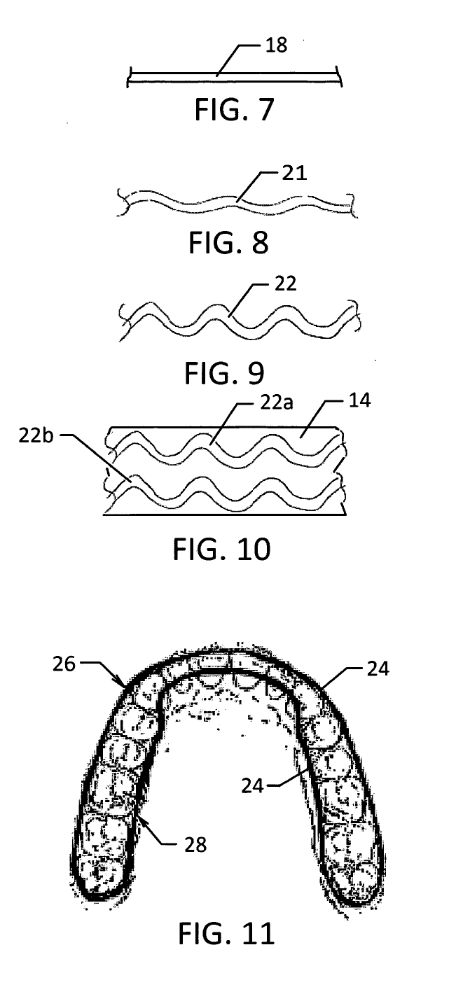

Referring now to FIG. 7, FIG. 8 and FIG. 9, the peripheral band can take on several distinct forms, such as the plain band 18 shown in FIG. 7 as well as FIG. 5, of a band 21 of a more spring shape, shown FIG. 8 or a band 22 of an even stronger spring shape, shown in FIG. 9. Any of these bands can be made from a single strip of tension material or from multiple strips, either aligned to each other or overlapping for additional strength. Referring also to FIG. 10, the peripheral bands can also be “stacked,” with one above the other. Peripheral band 22a is stacked above peripheral band 22b, adding to the “return” strength of the at least one peripheral band, in the present embodiment, the two peripheral bands.

Referring to FIG. 11, at least one peripheral band 24 covers the entire periphery of the orthodontic appliance, both on the outer periphery 26 and the inner periphery 28.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims. As many possible embodiments may be made of the invention without departing from the scope thereof, it is to be understood that all matter herein set forth or shown in the figures of the accompanying drawings is to be interpreted as illustrative and not in a limiting sense.

1. A method of making an orthodontic appliance for repositioning teeth or as a retainer, comprising in combination the steps of:
placing a dental model for the fabrication of an orthodontic aligner on a forming machine;
forming a soft flexible material onto the dental model, wherein the soft flexible material has adhesive material on the side facing away from the portion of the dental model to which it is thermoformed;
applying a flexible tension strain material to the adhesive side of the soft flexible material as at least one peripheral band; and
forming a harder, more rigid material over the soft flexible material which has the flexible tension strain material attached.

2. A method according to claim 1, wherein the flexible tension strain material is a fiber material.

3. A method according to claim 2, wherein the fiber sizes are in a range of from about 0.05 mm to about 12 mm.

4. A method according to claim 3, wherein the thickness of the soft flexible material is in a range from about 0.010 inches to about 0.015 inches.

5. A method according to claim 4, wherein the thickness of the harder, more rigid material is in a range of from about 0.020 inches to about to about 0.040 inches.

6. A method according to claim 3, wherein the thickness of the harder, more rigid material is in a range of from about 0.020 inches to about to about 0.040 inches.

7. A method according to claim 1, wherein the thickness of the soft flexible material is in a range from about 0.010 inches to about 0.015 inches.

8. A method according to claim 7, wherein the thickness of the harder, more rigid material is in a range of from about 0.020 inches to about to about 0.040 inches.

9. A method according to claim 1, wherein the thickness of the harder, more rigid material is in a range of from about 0.020 inches to about to about 0.040 inches.

10. A method according to claim 1 wherein the at least one peripheral band is primarily on the outside periphery of the orthodontic appliance.

11. A method of making an orthodontic appliance for repositioning teeth or as a retainer, comprising in combination the steps of:
preparing a dental model for the fabrication of an orthodontic aligner;
placing the dental model on a thermo-forming machine;
thermoforming a soft flexible material onto the dental model, wherein the soft flexible material has adhesive material covered by release liner, on the side facing away from the portion of the dental model to which it is thermoformed;
trimming off excess soft flexible material from the dental model;
peeling off the release liner to expose the adhesive material;
applying a predetermined length of flexible tension strain material to the adhesive side of the soft flexible material as at least one peripheral band;
thermoforming a harder, more rigid material over the soft flexible material which has the flexible tension strain material attached; and
trimming the excess hard material from the dental model.

12. A method according to claim 11, wherein the flexible tension strain material is a fiber material.

13. A method according to claim 12, wherein the fiber sizes are in a range of from about 0.05 mm to about 12 mm.

14. A method according to claim 13, wherein the thickness of the soft flexible material is in a range from about 0.010 inches to about 0.015 inches.

15. A method according to claim 14, wherein the thickness of the harder, more rigid material is in a range of from about 0.020 inches to about to about 0.040 inches.

16. A method according to claim 13, wherein the thickness of the harder, more rigid material is in a range of from about 0.020 inches to about to about 0.040 inches.

17. A method according to claim 11, wherein the thickness of the soft flexible material is in a range from about 0.010 inches to about 0.015 inches.

18. A method according to claim 17, wherein the thickness of the harder, more rigid material is in a range of from about 0.020 inches to about to about 0.040 inches.

19. A method according to claim 11, wherein the thickness of the harder, more rigid material is in a range of from about 0.020 inches to about to about 0.040 inches.

20. A method according to claim 11, wherein the soft flexible material also adhesive on its other side, covered by a release liner, the method further including the steps of:
removing the finished orthodontic appliance from the dental model;
removing the remaining release liner from the soft flexible material; and
placing the dental appliance into a patient's mouth.

21. A method according to claim 11, further including the step of etching the harder, more rigid material on the side facing the other materials to increase the adhesion to the other materials.

22. A method according to claim 11 wherein the at least one peripheral band is primarily on the outside periphery of the orthodontic appliance.

23. A dental appliance produced according to the method herein.

24. A dental appliance comprising a soft flexible material for fitting to a patient's teeth, a tension material affixed as a least one peripheral band to at least part of the soft flexible material, and a harder, more rigid material affixed to the tension material and to the soft flexible material.
